(19) United States
(12) Patent Application Publication
(10) Pub. No.: US 2025/0025996 A1
(43) Pub. Date: Jan. 23, 2025

(54) MULTIFUNCTIONAL HATCHETS WITH SAFETY-LOCKING SAWS AND REINFORCED CORES

(71) Applicant: InstaFire, LLC, Ogden, UT (US)

(72) Inventor: Konel S. Banner, Ogden, UT (US)

(21) Appl. No.: 18/355,081

(22) Filed: Jul. 19, 2023

(51) Int. Cl. B25F 1/00; B25F 1/04; B25G 1/01; B26B 29/00

(52) U.S. Cl. CPC B25F 1/006; B25F 1/04; B25G 1/01; B26B 29/00

(57) ABSTRACT

A multifunctional hatchet is provided. The multifunctional hatchet includes a head, a sheath, a handle linked to the head by a jointless connection and reinforced core, and a foldable saw with an open and closed position. The head includes a cutting edge, a cleft for pulling nails, and a poll end for hammering. The hatchet also includes a safety locking mechanism with a latch, a spring, and a first and second notch. Both notches are configured to inter-fit with the latch and produce an auditory feedback when the latch is pushed into either notch by the spring, alerting the wielder the saw is locked in the open or closed position. The handle includes a button connected to the spring, configured to withdraw the latch from the notches and permit the saw to move between the open and closed positions.

### TECHNICAL FIELD

The present disclosure generally relates to hatchets, and more particularly relates to the multifunctional hatchets with safety-locking saws.

### BACKGROUND

A hatchet is a single-handed striking tool with a sharp blade on one side used to cut and split wood. A saw is a tool consisting of a tough blade, wire, or chain with a hard toothed edge. It is used to cut through material, very often wood, though sometimes metal or stone. The cut is made by placing the toothed edge against the material and moving it back and forth, or continuously forward. Multi-tools combine several individual functions in a single unit. Multifunction tools may be specialized for use in certain activities. The advantage of a multitool is saving weight and space over a set of individual tools to perform the same functions.

### BRIEF DESCRIPTION OF THE DRAWINGS

FIG. 1 is a side view of a multifunctional hatchet in accordance with embodiments of the present technology.

FIG. 2A is a perspective view of a hatchet with a saw in accordance with embodiments of the present technology.

FIG. 2B is a reverse perspective view of a hatchet with a saw in accordance with embodiments of the present technology.

FIG. 3A is a side view of a sheath for a multifunctional hatchet in accordance with embodiments of the present technology.

FIG. 3B is a reverse perspective view of a sheath for a multifunctional hatchet in accordance with embodiments of the present technology.

FIG. 4 is a cut-away view of a safety locking mechanism on a foldable saw in a handle of a multifunctional hatchet in accordance with embodiments of the present technology.

### DETAILED DESCRIPTION

Those who work in search and rescue and emergency preparedness, as well as general outdoors hobbyists, must prepare for a variety of unknown variables while at the same time making judicious use of the limited space available in their packs. The tools afforded to them must be designed in consideration of these facts, in addition to the fact that they may be carried for miles over rough terrain, must be durable, and yet still flexible enough to be used for a variety of purposes, some of which may be outside of the intended design.

This need calls for multi-tools. Multi-tools, or multifunctional tools, combine several individual tools into a single unit. The advantage of a multitool is in its ability to save weight and space when compared to a set of individual tools that would perform the same functions in aggregate. However, by joining several disparate tools together in a single compact form, many multifunctional tools encounter the problem of durability. This problem is exacerbated when such tools are adapted for emergency situations, or the outdoors, where such tools are used in conditions far more demanding than what can be tested in a lab or factory setting. Safety is another concern for multifunctional tools. Those who wield a multitool may be familiar with each of the disparate component tools, whose use may be obvious when in their dedicated, individuated forms, but becomes more complicated—and less safe—when joined in a multitool. The reason for this can be explained by the necessity of providing each of the individuated tools with additional joints and armature which, while redundant to the functioning of the tools themselves, becomes essential when combining them with the multitool. In the multitool, these additional joints may be needed in order to fold the tools away or extend them out for use, depending on the wielder's desired mode of operation. Of course, with the addition of bladed tools and implements designed for piercing, stabbing, or cutting, providing multitools with this additional level of complexity creates opportunities for unintended harm, both to the wielder and others.

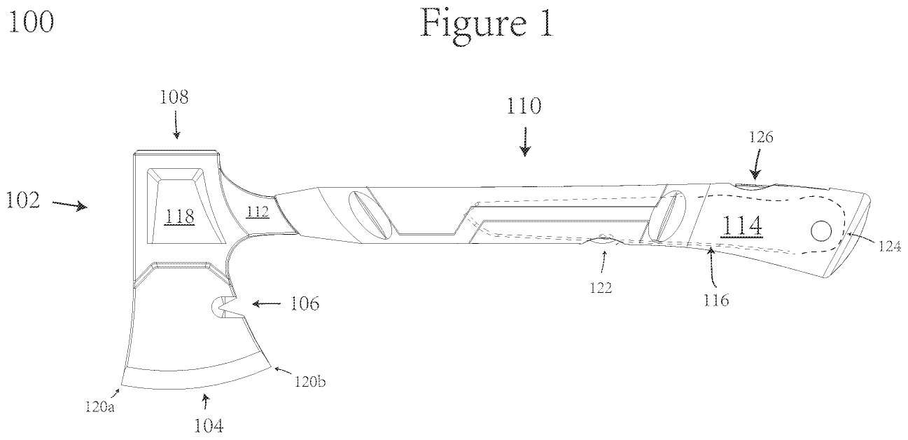

To address these drawbacks and others, various embodiments of the present disclosure provide multifunctional hatchets with safety locks and reinforced cores. FIG. 1 is a side view of a multifunctional hatchet 100 in accordance with embodiments of the present technology. The multifunctional hatchet 100 includes a head 102 and a handle 110, linked together by a jointless connection 112 and a reinforced core. The jointless connection 112 and the reinforced core are configured to absorb vibration and provide a stiffness to the hatchet 100. In some embodiments, the handle 110 and the head 102 can be formed from a single piece of steel. That is, taken together, the head 102 and the handle 110 can form a single seamless piece of steel. In further embodiments, the reinforced core can extend a length of the handle 110 and can include a steel center surrounded by a composite of wood and/or resin. The stiffness provided can enable the hatchet 100 to withstand pressures of up to five-hundred pounds of force (i.e., approximately 2,224 Newtons) applied to an end of the hatchet 100.

The head 102 includes a cutting edge 104. In some embodiments, the cutting edge 104 can include a flared top 120a and a flared bottom 120b. The flared top 120a and flared bottom 120b can expand an effective arc for the cutting edge 104. This expanded effective arc can enable the hatchet 100 to strike an object (e.g., a branch, log, or bough) at a more obtuse or acute angle and still allow the cutting edge 104 to find purchase and ultimately drive into the object in a cutting or hacking motion. These features can make it more difficult for a wielder to “miss” the object with the hatchet 100. In some embodiments, the head 102 can have an indentation 118 on each side. In these embodiments, the indentations 118 can reduce vibrations from traveling from the head 102 to the handle 110, and instead re-direct vibrations back to the cutting edge 104. In this way, the indentations 118 allow the head 102 to bury deeper into the object it's striking for a same amount of force.

The hatchet 100 includes a cleft 106 in an underside of the head 102, between the cutting edge 104 and the jointless connection 112. In some embodiments, the cleft 106 is a nail puller, a stake puller, a cat's paw, a claw hammer, or another tool with two edges configured in a V-shape. The edges of the cleft 106 can be used to pinch a head of an embedded object (e.g., a stake, nail, or pin), and—provided an amount of leverage—allow a wielder to extract the embedded object.

The head 102 also includes a poll end 108 on a side opposite to the cutting edge 104. The poll end 108 includes an additional mass of dense, flattened material that has a weight. In some embodiments, the poll end 108 is a hammer, a mallet, a club, or another tool which can be used to deliver an impact to a small area of an object (e.g., to drive nails, to shape metal, or to crush rock). In still further embodiments, the handle 110 includes a reverse hand grip, allowing a wielder to hold the hatchet 100 when the poll end 108 is facing away from the wielder so that the hatchet 100 can be used as a hammer.

The handle 110 includes a foldable saw 114 with a serrated edge and a safety locking mechanism. The foldable saw 114 can move between an open position and a closed position 116. In the open position, the saw 114 is extended out from and in line with the handle 110. In the closed position 116, as illustrated in FIG. 1, the saw 114 is folded within an inside portion of the handle 110. The safety locking mechanism locks the foldable saw 114 into the open position and the closed position 116 so that the saw 114 does not accidentally extend when the hatchet 100 is being used as a hatchet, hammer, or nail puller, nor does the saw 114 accidentally close when the hatchet 100 is being used as a saw. In some embodiments, the foldable saw 114 includes a raised protuberance 122 on a backside of the saw 114 opposite to the serrated edge. The protuberance 122 can provide a fingerhold, enabling a wielder to move the saw 114 between the closed position 116 and the open position without coming into contact with the serrated edge. In yet another embodiment, the foldable saw 114 includes a rounded joint 124. The rounded joint 124 can provide a smooth pivot between the closed position 116 and the open position, again further reducing risk of injury to a wielder.

The handle 110 includes a button 126. The button 126 is connected to the safety locking mechanism of the foldable saw 114. When depressed, the button 126 moves the safety locking mechanism to an unlocked position, permitting the saw to leave either the open or the closed positions 116. In some embodiments, the button 126 does not need to be held down while moving the foldable saw 114 between positions.

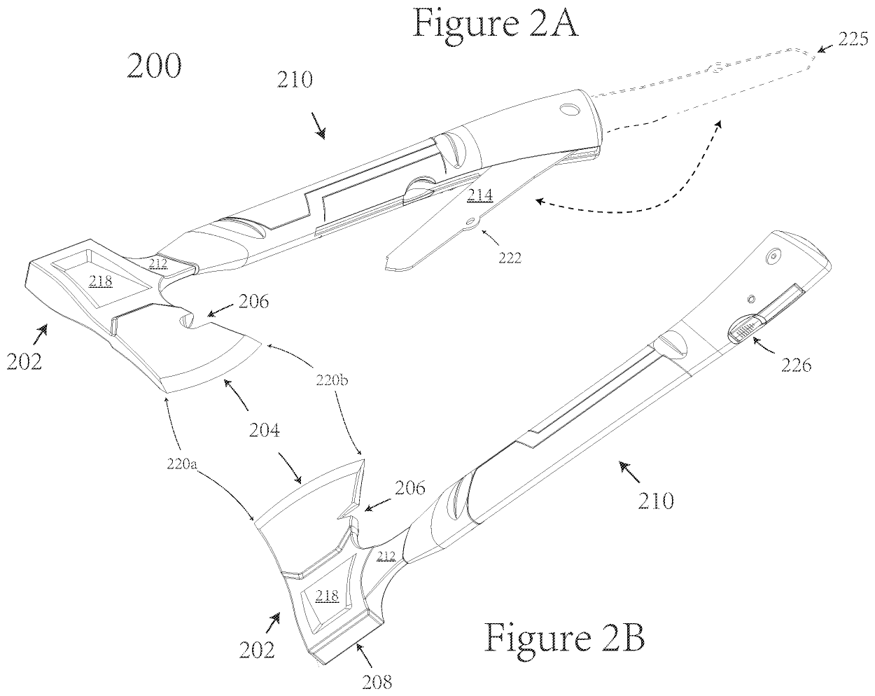

FIG. 2A is a perspective view of a hatchet 200 with a saw 214 in accordance with embodiments of the present technology. In the example hatchet 200 illustrated by FIG. 2A, the saw 214 is partially extended, and an open position 225 for the saw 214 is illustrated. The saw 214 includes a serrated edge and a safety locking mechanism. The safety locking mechanism locks the saw 214 into the open position 225 or into a closed position (e.g., the closed position 116 from FIG. 1) and prevents a wielder from accidentally cutting themselves on the saw 214 when they intend to use the hatchet 200 as a hatchet, or vice versa. In the open position 225, the saw is extended out from and in line with the handle 210. In the closed position, the saw 214 is folded within the inside portion of the handle 210. In some embodiments, the saw 214 includes a raised protuberance 222 on a backside of the saw 214 opposite to the serrated edge. The protuberance can provide a fingerhold to allow the saw to safely move between the closed and open positions 225.

The hatchet 200 includes a cutting head 202 and a handle 210. In some embodiments, the cutting head 202 and the handle 210 can be connected by a jointless neck 212. The hatchet 200 includes a reinforced core that is configured to absorb vibration and provide a stiffness to the hatchet 200, enabling it to withstand pressures of up to five-hundred pounds. In some embodiments, the reinforced core extends a length of the handle and includes steel surrounded by a composite of wood and resin. In still other embodiments, the cutting head 202 and the handle 210 are formed from a single piece of steel configured for durability.

FIG. 2B is a reverse perspective view of a hatchet with a saw in accordance with embodiments of the present technology. From this perspective, a poll end 208 of the cutting head 202 is visible. The poll end 208 can be configured for hammering, and in some embodiments may include an additional weight and a reverse grip on the handle 210. The poll end 208 includes an additional mass of dense, flattened material that has a weight. In some embodiments, the poll end 208 is a hammer, a mallet, a club, or another tool which can be used to deliver an impact to a small area of an object (e.g., to drive nails, to shape metal, or to crush rock). In still further embodiments, the handle 210 includes a reverse grip, allowing a wielder to hold the hatchet 200 when the poll end 208 is facing away from the wielder so that the hatchet 200 can be used as a hammer.

Other examples of the hatchet 200 include a blade 204 as well as a V-shaped gap 206 for pulling nails and stakes. In some embodiments, the V-shaped gap 106 is a nail puller, a stake puller, a cat's paw, a claw hammer, or another tool with two edges configured in a V-shape. The edges of the cleft 106 can be used to pinch a head of an embedded object (e.g., a stake, nail, or pin), and—provided an amount of leverage—allow a wielder to extract the embedded object.

The cutting head 202 has sides, and in some embodiments the side have an indentation 218 that allow the cutting head 202 to bury deeper into the object it's striking. From the reverse perspective of FIG. 2B, a button 226 is visible on the handle 210. The button 226 is connected to the safety locking mechanism of the saw 214, and is configured to release the safety locking mechanism when depressed, thereby enabling the saw to rotate between the open position 225 and the closed positions.

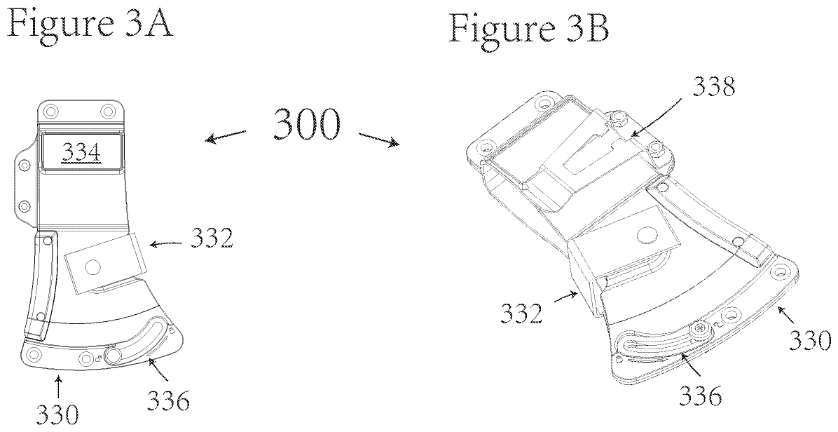

As an additional safety feature, the hatchets of the foregoing disclosed embodiments include a sheath. FIG. 3A is a side view of a sheath 300 for a hatchet in accordance with embodiments of the disclosed technology. The sheath 300 can be detachable. The sheath 300 includes a protective portion 330 to cover a blade or cutting edge of the hatchet, a strap 332 to secure the sheath 300 to a hatchet head, and a sharpening pad 334 on a first side of the sheath 300. In some embodiments, the sharpening pad 334 can include honing steel. The sheath also includes a lock 336 configured to prevent the sheath from being removed from the hatchet head. In some embodiments, the lock 336 can include a built-in lock with a sliding piece that is configured to move between an unlocked position and a locked position. In such embodiments, when the sliding piece is in the locked position, the sheath 300 is prevented from being removed from the head of the hatchet. In further embodiments, the sheath 300 can be configured to secure to and cover the head of the hatchet such that the sheath 300 forms a grip when the saw is in the open position and the hatchet is being used as a saw.

FIG. 3B is a reverse perspective view of a sheath 300 for a multifunctional hatchet in accordance with embodiments of the present technology. The sheath 300 includes a clip 338 configured to hook over and attach the sheath 300 to an external carrier. The clip 338 that has bolts which can be tightened or removed, allowing the clip 338 to be fixed to an opposing side of the sheath 300. In this way, the sheath 300 can accommodate right-handed or left-handed users of the hatchet, e.g., by allowing the user to affix the sheath 300 to a belt-loop such that the head of the hatchet (and the protective portion 330 of the sheath 300) are oriented towards a back of the user, and the user can also quickly and easily undo the strap 332 and open the lock 336. Both of these operations can be performed from either side of the sheath 300 in such embodiments.

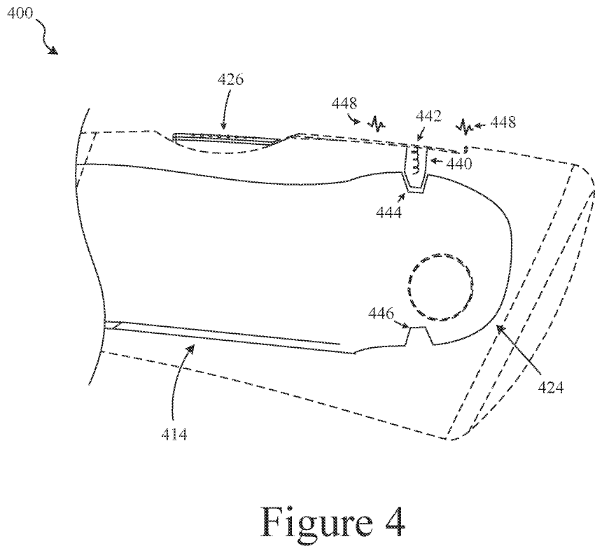

For a more detailed perspective of an additional safety feature, FIG. 4 illustrates a cut-away view of a safety locking mechanism 400 on a foldable saw in a handle of a multifunctional hatchet in accordance with embodiments of the present technology. As illustrated, this safety locking mechanism 400 can be the same as the safety locking mechanisms disclosed in the foregoing embodiments, or the previously discussed safety locking mechanisms may provide alternate mechanisms for locking the saw in place and preventing injuries. The safety locking mechanism includes a latch 440. The latch 440 is configured to fit conformally with a first notch 444 and a second notch 446 located on a joint 424 belonging to the saw. When locked into the first notch 444, the latch 440 can hold the saw in a closed position, as illustrated. When locked in the second notch 446, the latch 440 can hold the saw in an open position. The joint 424 can be a rounded joint, as illustrated, enabling the saw to pivot smoothly between the closed position and the open position.

In some embodiments, the latch 440 has a shape and a spring 442. The first notch 444 and the second notch 446 can have angled sidewalls that are configured to match the shape of the latch 440 and inter-fit. This angled fit between the notches, 444 and 446, and the latch 440 can ensure a tighter, more secure grip holding the saw in place, and ensuring the saw is less likely to move out of position once locked. The safety locking mechanism 400 can include a button 426, which provides an interface to the safety locking mechanism 400. Connected to the spring 442, and configured to compress the spring 442 when depressed, the button 426 withdraws the latch 440 from the first notch 444 and the second notch 446, permitting the saw to move between the open and the closed positions.

The spring 442 can store potential energy when button 426 is pressed and the latch 440 is withheld from the notches 444 and 446. When the button 426 is released, the spring 442 can push the latch 440 into the joint 424 of the saw as the saw rotates between positions, and push the latch 440 into the notches 444 or 446 when the latch is positioned above them. This action, of the latch 440 being pushed or falling into the notches 444 and 446, produces an auditory feedback 448. The auditory feedback 448 alerts a user to the safety locking mechanism 400 being engaged and of the saw being safely secured in either the open position or the closed position.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, the terms “vertical,” “lateral,” “upper,” “lower,” “above,” and “below” can refer to relative directions or positions of features in the various illustrated embodiment in view of the orientation shown in the Figures. For example, “upper” or “uppermost” can refer to a feature positioned closer to the top of a page than another feature. These terms, however, should be construed broadly to include embodiments having other orientations, such as inverted or inclined orientations where top/bottom, over/under, above/below, up/down, and left/right can be interchanged depending on the orientation.

It should be noted that the methods described above describe possible implementations, and that the operations and the steps may be rearranged or otherwise modified and that other implementations are possible. Furthermore, embodiments from two or more of the methods and/or devices may be combined.

From the foregoing, it will be appreciated that specific embodiments of the invention have been described herein for purposes of illustration, but that various modifications may be made without deviating from the scope of the invention. Rather, in the foregoing description, numerous specific details are discussed to provide a thorough and enabling description for embodiments of the present technology. One skilled in the relevant art, however, will recognize that the disclosure can be practiced without one or more of the specific details. In other instances, well-known structures or operations often associated with various embodiments of the disclosure are not shown, or are not described in detail, to avoid obscuring other aspects of the technology. In general, it should be understood that various other devices, systems, and methods in addition to those specific embodiments disclosed herein may be within the scope of the present technology.

What is claimed is:

1. A multifunctional hatchet, comprising:
a head, the head including a cutting edge, a cleft in an underside configured for pulling nails, and a poll end opposite the cutting edge configured for hammering;
a handle linked to the head by a jointless connection and a reinforced core, the jointless connection and reinforced core configured to absorb vibration;
a foldable saw including a serrated edge, the saw configurable between an open position in which the saw is extended out from and in line with the handle and a closed position in which the saw is folded within an inside portion of the handle; and
a safety locking mechanism, the safety locking mechanism comprising:
a latch, a spring, a first notch with angled sidewalls configured to inter-fit with a shape of the latch and produce an auditory feedback when the spring pushes the latch into the first notch and locks the saw in the open position, and a second notch with angled sidewalls configured to inter-fit with the shape of the latch and produce the auditory feedback when the spring pushes the latch into the second notch and locks the saw in the closed position, and
a button connected to the spring and configured to compress the spring when depressed and withdraw the latch from the first and second notch, permitting the saw to move between the open and the closed positions; and
a sheath, the sheath including:
a protective portion covering the cutting edge, a strap configured to secure the sheath to the head, a clip configured to hook over and secure the sheath to an external carrier, a sharpening pad, and a lock configured to prevent the sheath from being removed from the head.

2. The multifunctional hatchet of claim 1, wherein the reinforced core extends a length of the handle and comprises steel surrounded by a composite of wood and resin.

3. The multifunctional hatchet of claim 1, wherein the handle and the head are formed of a seamless piece of steel.

4. The multifunctional hatchet of claim 1, wherein the head further comprises sides, and wherein each side has an indentation configured to reduce vibrations from traveling from the head to the handle.

5. The multifunctional hatchet of claim 1, wherein the cutting edge includes a flared top and a flared bottom configured to expand an effective arc for the cutting edge.

6. The multifunctional hatchet of claim 1, wherein the foldable saw further comprises a raised protuberance on a backside of the saw opposite to the serrated edge, the protuberance configured to provide a fingerhold to move the saw between the closed and open positions.

7. The multifunctional hatchet of claim 1, wherein the foldable saw further comprises a rounded joint where the saw attaches inside the handle, configured to provide a smooth pivot between the closed position and the open position.

8. The multifunctional hatchet of claim 1, wherein the first and second notches include angled sides configured to match a shape of the safety locking mechanism and provide a conformal fit with the safety locking mechanism when the saw is in the open and closed position.

9. The multifunctional hatchet of claim 1, wherein the sheath is detachable and is configured to secure to and cover the head of the hatchet such that it forms a hand grip for the saw when the saw is in the open position.

10. The multifunctional hatchet of claim 1, wherein the clip comprises a reversible clip with bolts configured to be opened and closed such that the clip can be removed and tightened on an opposing side of the sheath.

11. The multifunctional hatchet of claim 1, wherein the lock comprises a sliding piece configured to move between an unlocked position and a locked position, and wherein the sliding piece in the locked position prevents the sheath from being removed from the head of the hatchet.

12. The multifunctional hatchet of claim 1, wherein the sharpening pad comprises a honing steel.

13. A hatchet, comprising:
a cutting head and a handle, the cutting head and the handle including a reinforced core configured to absorb vibration,
wherein the cutting head and the handle are formed from a single piece of steel, and
wherein the reinforced core comprises steel surrounded by a composite of wood and resin;
a saw joined to the handle, the saw configurable between an open position and a closed position; and
a safety locking mechanism, the safety locking mechanism including:
a latch connected to a spring,
a first notch configured to inter-fit with the latch and produce an auditory feedback when the saw is locked in the open position,
a second notch configured to inter-fit with the latch and produce the auditory feedback when the saw is locked in the closed position, and
a button on the handle configured to compress the spring and release the latch from the first and second notch when depressed.

14. The hatchet of claim 13, wherein the cutting head further comprises a V-shaped gap configured for pulling nails.

15. The hatchet of claim 13, wherein the cutting head further comprises a poll end, the poll end including a dense flattened material, and wherein the poll end is configured for hammering.

16. The hatchet of claim 15, wherein the handle includes an opposing grip configured to enable the poll end to be wielded as a hammer.

17. The hatchet of claim 13, further comprising a sheath, the sheath including:
a protective portion covering the cutting head;
a strap configured to secure the sheath to the head;
a clip configured to hook over and secure the sheath to an external carrier;
a sharpening pad; and
a lock configured to prevent the sheath from being removed from the head.

18. The hatchet of claim 13, wherein the head further comprises sides, each side having an indentation configured to reduce vibrations from traveling from the head to the handle.

19. The hatchet of claim 13, wherein the saw further comprises a rounded joint where the saw attaches inside the handle, configured to provide a smooth pivot between the closed position and the open position, and wherein the first and second notches include angled sides configured to match a shape of the latch and provide a conformal fit with the latch when the saw is locked in the open and closed position.

20. The hatchet of claim 13, wherein the first and second notches include angled sides configured to match a shape of the latch and provide a conformal fit with the latch when the saw is in the open and closed position.
